(19) United States
(12) Patent Application Publication
(10) Pub. No.: US 2010/0290340 A1
(43) Pub. Date: Nov. 18, 2010

(54) METHOD FOR PROTECTION SWITCHING

(75) Inventors: Kwang Koog LEE, Daejeon (KR); Jeong-dong RYOO, Daejeon (KR); Sang-Min LEE, Daejeon (KR); Daeub KIM, Daejeon (KR); Jea Hoon YU, Daejeon (KR); Tae Whan YOO, Daejeon (KR)

Correspondence Address: LADAS & PARRY LLP, 224 SOUTH MICHIGAN AVENUE, SUITE 1600, CHICAGO, IL, 60604, US

(73) Assignee: ELECTRONICS AND TELECOMMUNICATIONS RESEARCH INSTITUTE, Daejeon (KR)

(21) Appl. No.: 12/774,859

(22) Filed: May 6, 2010

(30) Foreign Application Priority Data
May 15, 2009 (KR) 10-2009-0042732
Dec. 18, 2009 (KR) 10-2009-0127083

(51) Int. Cl. H04L 12/56; G06F 11/00

(52) U.S. Cl. 370/225; 370/400

(57) ABSTRACT

A method for protection switching of a ring network, which includes a plurality of nodes disposed in a ring shape, includes: allowing a node adjacent to a failure link among the plurality of nodes to generate a failure protection switching frame when the failure link is generated in the ring network; allowing the node adjacent to the failure link to transmit the failure protection switching frame to an adjacent node; allowing each of the plurality of nodes to delete address lists connected with the ring network except for an external network (hereinafter referred to as subnet) from their own forwarding table; allowing each of the plurality of nodes to transmit a subnet address list protection switching frame including a subnet address list; and allowing a node receiving the subnet address list protection switching frame to update the forwarding table on the basis of the subnet address list included in the frame.

### CROSS-REFERENCE TO RELATED APPLICATION

This application claims priority to and the benefit of Korean Patent Application Nos. 10-2009-0042732 and 10-2009-0127083 filed in the Korean Intellectual Property Office on May 15, 2009 and Dec. 18, 2009, the entire contents of which are incorporated herein by reference.

### BACKGROUND OF THE INVENTION

(a) Field of the Invention

The present invention relates to a method for protection switching.

(b) Description of the Related Art

In an Ethernet-based ring network, the forwarding table of each ring node should be built not to form an endless loop. The loop prevention can be solved by logically blocking a predetermined link in the ring network. Herein, the ring network may exist not in a single ring network structure but in a hierarchical multi-ring network form allowing connection of a plurality of rings. A ring network (major ring) positioned above and a ring network (sub-ring) positioned below may be connected through one or two ring connection nodes.

At this time, since all multi-ring networks are not considered as one Ethernet based ring network, the ring networks constituting the multi-ring network possess their own blocking links.

In the case where a failure occurs in any link in the ring network, a logically blocked link moves to a link having a failure in which blocking is physically performed, such that it is possible to prevent the endless loop as well as ensure the connectivity of the ring node. In the case where all failure links of the ring are restored, blocking caused due to occurrence of the failure is deleted and the logical blocking is reestablished.

Meanwhile, promising pre-selecting an alternative route against a failure situation is referred to as protection switching. In an Ethernet ring, in a case of performing ring protection switching by a link or node failure, all nodes need a new forwarding table for the changed topology because their forwarding table that is previously used is no longer valid. Therefore, each node deletes all contents of its forwarding table, and then it starts to build a new forwarding table by using source MAC address learning for data frames.

A node receiving a data frame including a destination address (DA) that is not yet learned during the address learning process broadcasts corresponding frames to all ports. In general, when the source address of the frame is not learned in the forwarding table, the source address of the frame and a port number receiving the frame are recorded in the forwarding table. If the source address is learned in the forwarding table, only the received port number is recorded. That is, by deleting all the forwarding tables right after protection switching, whenever a data frame designating an address that is not recorded in the forwarding table as a destination is received, the frame is copied and transmitted to all ports except the reception port. The process is repeated until all destination addresses are learned. Therefore, topology change of the ring network by a link failure or restoration condition excessively generates the quantity of data frames transmitted within the ring network in comparison with a normal state, thereby causing congestion of the ring network and even deteriorating the service quality due to the delay and loss of the frame.

As such, since the capacity or bandwidth of the link of the ring network should be unnecessarily secured in order to cope with deterioration of the service quality caused due to the protection switching, utilization of resources may be inefficiently operated. Moreover, in the case where the capacity or bandwidth of the link of the ring network is limited, a buffer having a large capacity may be provided in order to prevent the loss of the frame, but in this case, it is difficult to perform rapid protection switching.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a method for protection switching having advantages of preventing a transition phenomenon in which a traffic amount is overshot due to a transmission table initialized while protection switching in an Ethernet ring network.

An exemplary embodiment of the present invention provides a method for protection switching of a ring network that includes a plurality of nodes disposed in a ring shape, including:

A method for protection switching of a ring network, which includes a plurality of nodes disposed in a ring shape, comprising: allowing the plurality of nodes to delete address lists connected with the ring network from their forwarding tables when topology of the ring network is changed; allowing each of the plurality of nodes to transmit a subnet address list with ports associated with subnets in its forwarding table; and allowing each of the plurality of nodes to update the forwarding table on the basis of the subnet address list.

The updating a forwarding table may be performed on the basis of a source address learning process.

The case when the topology of the ring network is changed may include a case when a failure link occurs in the ring network, and the protection switching method may further include allowing a node adjacent to the failure link among the plurality of nodes to generate a failure protection switching frame when the failure link occurs in the ring network, and allowing the node adjacent to the failure link to transmit the failure protection switching frame to an adjacent node.

The deleting the address list may include allowing the node adjacent to the failure link to delete the address list after transmitting the failure protection switching frame.

The method for protection switching may further include allowing each of the plurality of nodes to receive the failure protection switching frame.

The deleting the address list may include allowing each node to delete an address list connected to the ring network in its forwarding table after receiving the failure protection switching frame.

The transmitting a subnet address list may include transmitting the subnet address list included in a subnet address list protection switching frame.

In the transmitting the subnet address list, the node adjacent to the failure link may transmit the subnet address list protection switching frame in an opposite side to the failure link.

The case when the topology of the ring network is changed may include a case when the failure link is restored in the ring network, and the protection switching method may further include allowing the node adjacent to the failure link to generate a restoration protection switching frame notifying the restoration, and allowing each of the plurality of nodes to receive the restoration protection switching frame.

The method for protection switching may further include setting logical blocking after receiving the restoration protection switching frame.

The method for protection switching may further include allowing a node managing the logical blocking among the plurality of nodes to generate a blocking protection switching frame notifying that the logical blocking is set, and allowing each node of the plurality of nodes to receive the blocking protection switching frame.

The method for protection switching may further include allowing each of the plurality of nodes to delete a list connected with the ring network from the forwarding table, allowing each of the plurality of nodes to transmit the subnet address list with ports connected with subnets in its forwarding table, and allowing each of the plurality of nodes to update the forwarding table on the basis of the subnet address list.

The transmitting the subnet address list may include transmitting the subnet address list included in the subnet address list protection switching frame.

The transmitting the subnet address list may further include allowing the node managing the logical blocking to transmit the source address list protection switching frame to an opposite side to the logical blocking.

The transmitting the subnet address list may include allowing the node managing the logical blocking to receive the source address list protection switching frame from a port where the logical blocking is positioned, wherein the node managing the logical blocking may not perform processing of the source address list frame and not transmit the source address list protection switching frame to the opposite side.

Another embodiment of the present invention provides a method for protection switching of a network including a plurality of nodes connected in a structure of a plurality of rings, that includes: when a failure occurs in a lower ring network of the ring network, allowing a node that connects an upper ring network with the lower ring network and is included in the ring network among the plurality of nodes to delete all entries connected with the ring networks from its forwarding table.

Yet another embodiment of the present invention provides a method for protection switching of a node included in a ring network that includes deleting address lists connected with the ring network from a node's own forwarding table when a topology of the ring network is changed, transmitting a subnet address list to an adjacent node, receiving a subnet address list from the adjacent node, and updating the forwarding table on the basis of the subnet address list received from the adjacent node.

The updating a forwarding table may be performed on the basis of a source address learning process.

The case when the topology of the ring network is changed may include a case when a failure link occurs in the ring network, and the protection switching method further include generating a failure protection switching frame when the node is a node adjacent to the failure link and transmitting the failure protection switching frame to the adjacent node.

The deleting the address list may include deleting the address list after transmitting the failure protection switching frame, the transmitting the subnet address list may include transmitting the subnet address list protection switching frame to an opposite side to the failure link by including the subnet address list in a subnet address list protection switching frame, when the subnet address list is larger than the maximum transmission size of the subnet address list protection switching frame, the subnet address list protection switching frame may be divided and transmitted, and the node may separately process the divided subnet address list protection switching frame.

The case when the topology of the ring network is changed may include a case when the failure link is restored in the ring network, and the protection switching method may further include: generating a restoration protection switching frame notifying the restoration when the node is a node adjacent to the failure link; transmitting the restoration protection switching frame; receiving a blocking protection switching frame notifying that logical blocking is set from a node managing the logical blocking after the logical blocking is set; deleting a list connected with the ring network from the forwarding table; transmitting the subnet address list to the adjacent node; receiving the subnet address list from an adjacent node; and updating the forwarding table on the basis of the subnet address list received from the adjacent node.

The transmitting the subnet address list may include transmitting the subnet address list included in the subnet address list protection switching frame, and when the subnet address list is larger than the maximum transmission size of the subnet address list protection switching frame, the subnet address list protection switching frame may be divided and transmitted, and each of the plurality of nodes may separately process the divided subnet address list protection switching frame.

The case when the topology of the ring network is changed may include a case when the failure link is restored in the ring network and the logical blocking is set, and the protection switching method may include transmitting the source address list protection switching frame to an opposite side to the logical blocking when the node is the node managing the logical blocking and receiving the source address list protection switching frame from a port where the logical blocking is positioned, and the node does not process the source address list protection switching frame without transmitting the source address list protection switching frame to the opposite side.

### BRIEF DESCRIPTION OF THE DRAWINGS

FIG. 1 is a diagram schematically showing a network according to an embodiment of the present invention;

FIG. 2 is a diagram showing a logical blocking link in a network according to an embodiment of the present invention;

FIG. 3 is a diagram showing a case where a failure occurs in a network according to an embodiment of the present invention;

FIG. 4 is a diagram showing generation of a new forwarding table in a network according to an embodiment of the present invention;

FIG. 5 is a diagram showing restoration of a link in a network according to an embodiment of the present invention;

FIG. 6 is a diagram showing restoration of a failure in a network according to an embodiment of the present invention; and

FIG. 7 is a diagram showing generation of a new forwarding table in a network according to an embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In the specification, unless explicitly described to the contrary, the word “comprise” and variations such as “comprises” or “comprising” will be understood to imply the inclusion of stated elements but not the exclusion of any other elements.

Hereinafter, a method for managing a network according to an embodiment of the present invention will be described in detail with reference to the accompanying drawings.

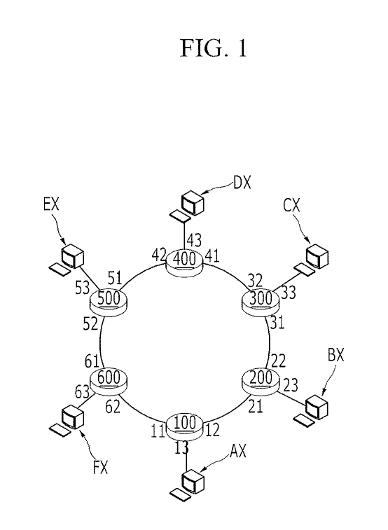

FIG. 1 is a diagram schematically showing a network according to an embodiment of the present invention.

Referring to FIG. 1, the network according to the embodiment of the present invention has a ring shape, and for example, includes six nodes 100, 200, 300, 400, 500, and 600. The nodes 100 to 600 include three ports 11, 12, 13, 21, 22, 23, 31, 32, 33, 41, 42, 43, 51, 52, 53, 61, 62, and 63, respectively. The ports 11, 12, 21, 22, 31, 32, 41, 42, 51, 52, 61, and 62 are connected to links connecting the nodes 100 to 600 disposed in the network having the ring shape, and the ports 13, 23, 33, 43, 53, and 63 are connected to clients AX, BX,

CX, DX, EX, and FX positioned outside of the ring network. That is, each of the nodes 100 to 600 has two ring ports and subnet ports that can be connected with an external network. The subnet port may be plural. For example, the network may be based on the Ethernet.

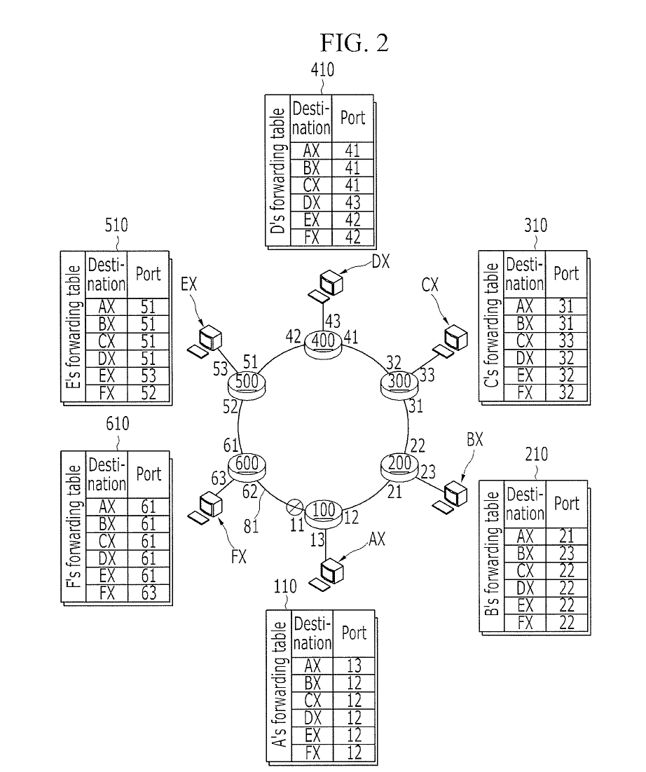

Hereinafter, a method for protection switching of a network according to an embodiment of the present invention will be described in detail with reference to FIGS. 2 to 7.

FIG. 2 is a diagram showing setting a logical blocking link in a network according to an embodiment of the present invention.

Referring to FIG. 2, the logical blocking link on the network shown in FIG. 1 may be set as a link 81 connecting the port 11 of the node 100 and the port 62 of the node 600 to each other. At this time, the link 81 set as the logical blocking link is referred to as a ring protection link (RPL), and the node 100 that is connected to the ring protection link 81 to manage logical blocking is referred to as a ring protection link owner.

It is assumed that forwarding tables (filtering database, FDB) 110, 210, 310, 410, 510, and 610 of the nodes 100 to 600 are pre-established considering the ring protection link 81. Each of the forwarding tables 110 to 610 indicates which port the frame is transmitted through depending on a destination address.

That is, referring to the forwarding table 110, since the link 81 connecting the port 11 of the node 100 and the port 62 of the node 600 to each other is determined as the ring protection link, if the destination address is a client FX, a port to be transmitted is determined as the port 12, not port 11, and referring to the forwarding table 610, if the destination address is a client AX, the port to be transmitted is determined as the port 61, not the port 62.

Meanwhile, a failure may occur in the network where the logical blocking link is determined. Then, a signal fail-automatic protection switching frame is generated and the generated signal fail-automatic protection switching frame is transmitted so that all the nodes 100 to 600 of the ring network can recognize the failure situation. Thereafter, in the forwarding tables 110 to 610, lists connected with the ring network except for ports connected with the external network are deleted.

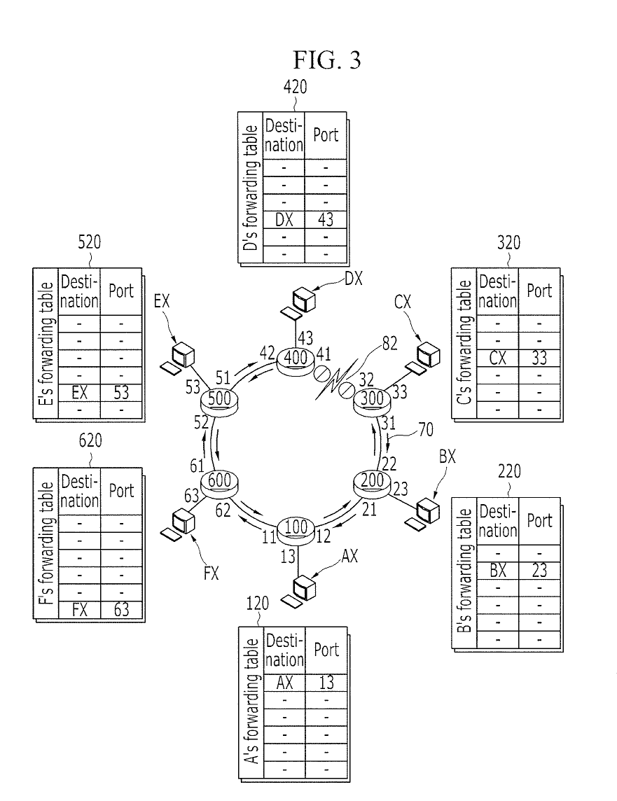

This will be described in detail with reference to FIG. 3. FIG. 3 is a diagram showing a case where a failure occurs in a network according to an embodiment of the present invention.

Referring to FIG. 3, a bidirectional failure occurs in a link 82 connecting the node 300 and the node 400 to each other. The nodes 300 and 400 detect the signal failure and then block the failed ports 32 and 41, respectively. Then, each node generates and transmits a signal fail-automatic protection switching frame to inform the other nodes 100, 200, 500, and 600 of the failure situation.

After the failure occurs, address lists included in the forwarding tables 110 and 610 of the nodes 100 to 600 are no longer valid by the changed ring topology. Thus, the rest address lists except for address lists corresponding to the ports 33 and 43 in the forwarding tables 310 and 410 of the nodes 300 and 400 are deleted. Further, in the nodes 200 and 500 receiving the signal fail-automatic protection switching frame 70, the remaining address lists except for address lists corresponding to the ports 23 and 53 are also deleted. In addition, in the nodes 100 and 600 receiving the signal fail-automatic protection switching frame 70, the remaining address lists except for address lists corresponding to the ports 13 and 63 are also deleted. Meanwhile, after the node 100 receives the signal fail-automatic protection switching frame 70, the node 100 removes the logical blocking of the port 11 connected with the ring protection link.

Since removing the logical blocking may allow the signal fail-automatic protection switching frame 70 to be repeatedly received, the forwarding table is flushed only when the signal fail-automatic protection switching frame 70 is firstly received. Except for the lists connected with the external network, the flushed forwarding tables 120, 220, 320, 420, 520, and 620 are shown in FIG. 3.

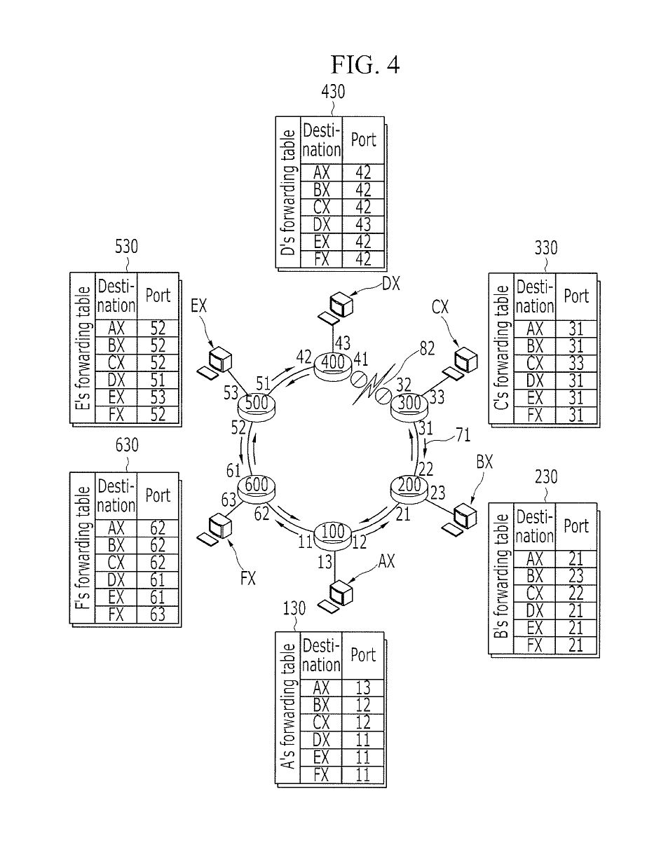

After some of the lists of the forwarding tables 110 to 610 are deleted, the ring nodes exchange their own forwarding table lists connected with the external network to and from each other to build new forwarding table lists for the new ring topology. This will be described in detail with reference to FIG. 4.

FIG. 4 is a diagram showing generation of a new forwarding table list in a network according to an embodiment of the present invention.

Referring to FIG. 4, each of the nodes 100 to 600 of the network, generate a subnet address list protection switching frame (automatic protection switching-subnet address list, APS-SAL) 71 and includes information on the address lists connected with the port connected with the external network of the node in the frame. For example, the node 100 generates the automatic protection switching-subnet address list (APS-SAL) frame 71 including information of the client AX connected to the port 13. This process is performed just after transmitting a failure protection switching frame 70 in the failure neighboring nodes 300 and 400, and is performed just after receiving the failure protection switching frame in other nodes 100, 200, 500, and 600.

The generated automatic protection switching-subnet address list is bidirectionally transmitted in bi-directions of each of the nodes 100 to 600 and transferred to all the nodes of the ring network. However, the automatic protection switching-subnet address list frame 71 is transmitted to only the ports 31 and 42 opposite to the link 82 having the failure in the failure neighboring nodes 300 and 400.

In the case where the subnet address list is larger than the maximum transmission unit (MTU) of the automatic protection switching-subnet address list frame 71, the automatic protection switching-subnet address list frame 71 may be divided into a plural number to be transmitted. Meanwhile, since each of the nodes 100 to 600 receiving the automatic protection switching-subnet address list frame 71 which is divided and transmitted can separately processes it, the divided and transmitted automatic protection switching-subnet address list frame 71 does not need to be reassembled in a reception node.

When each of the nodes 100 to 600 receives an automatic protection switching-subnet address list 71 having addresses of clients from other nodes the automatic protection switching-subnet address list frame 71 is copied, and thereafter the copied automatic protection switching-subnet address list frame 71 is transmitted to an opposite direction and then the node starts to update its forwarding table on the basis of the copied automatic protection switching-subnet address list frame 71. This operation named indirect MAC address learning process enables a node to build the forwarding table as if it received multiple individual data frames. That is, in FIG. 3, in the deleted address list, the forwarding tables 130 to 630 are updated by performing the indirect source address learning function for the automatic protection switching-subnet address list frame that each of the nodes 100 to 600 transmits.

In the forwarding tables 130, 230, 330, 430, 530, and 630, which port the frame is transmitted depending on the destination address of a data frame by considering the link 82 having the failure is disclosed. That is, referring to the forwarding table 330, when the destination address of a data frame originated from client CX is client DX, the port to be transmitted in node 300 is determined as the port 31, not the port 32.

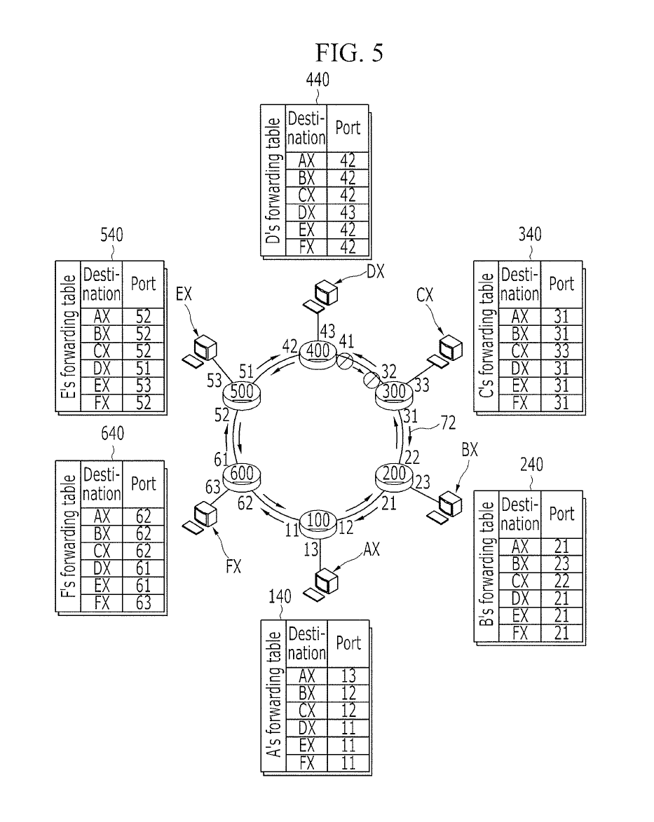

Meanwhile, when the failure which occurs in the link is restored, a no request-automatic protection switching (NR-APS) frame is generated and the generated request-automatic protection switching (NR-APS) frame is transmitted. This will be described in detail with reference to FIG. 5.

FIG. 5 is a diagram showing restoration of a link in a network according to an embodiment of the present invention.

Referring to FIG. 5, when the failure that occurs in the link is restored, the failure neighboring nodes 300 and 400 generate and transmit the generated no request-automatic protection switching frame 72 to the neighboring nodes 200 and 500, and the nodes 200 and 500 receiving the no request-automatic protection switching frame 72 transmits the received no request-automatic protection switching frame 72 to the opposite port neighboring the nodes 100, and 600. Finally, the nodes 100, 200, 500, and 600 receiving the no request-protection switching frame 72 recognize that the failure is restored.

After recognizing the restoration of the failure, a ring protection link owner node reconfigures the logical blocking. At this time, an RPL block-automatic protection switching (RB-APS) frame is generated, and the generated RB-APS frame is transmitted so that all the nodes 100 to 600 of the network recognize that the logical blocking is reconfigured.

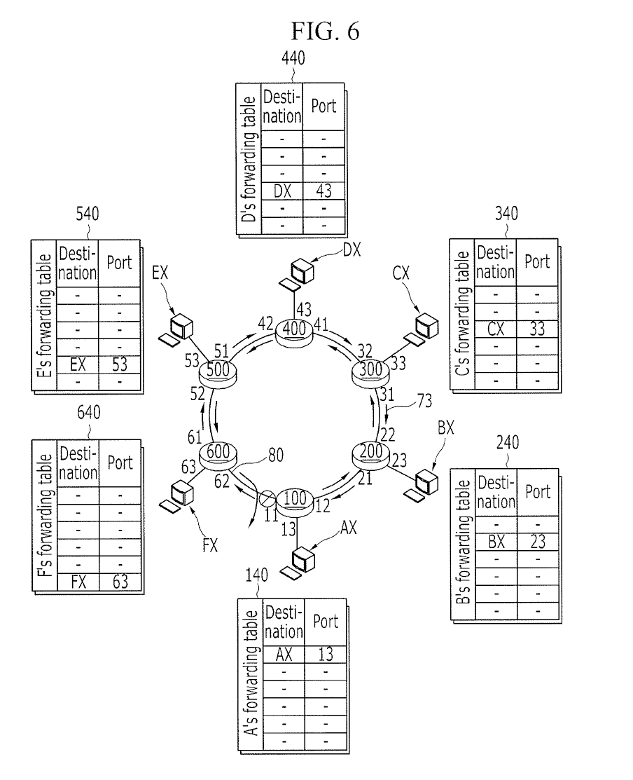

Meanwhile, since reestablishing the logical blocking means that topology information of the ring network is changed like the failure situation, all the nodes of the ring network need to delete the forwarding tables 130 to 630 again. Hereinafter, referring to FIG. 6, this will be described in detail.

FIG. 6 is a diagram showing a case where a failure restored in a network according to an embodiment of the present invention.

Referring to FIG. 6, the ring protection link owner 100 receiving the no request-protection switching frame from the nodes 300 and 400 recognizes that the failure of the network is restored, and thereafter reconfigures the logical blocking deleted when the link has the failure. At this time, the ring protection link owner 100 may adopt a wait-to-restore timer setting the logical blocking after a predetermined time.

Thereafter, the ring protection link owner 100 generates and transmits an RPL block-automatic protection switching frame 73 indicating that the logical blocking is set to the neighboring nodes 200 and 600, and the nodes 200 and 600 transmit the RPL block-automatic protection switching frame 73 to the neighboring nodes 500 and 300 and the nodes 500 and 300 transmit an RPL block-automatic protection switching frame 73 to the neighboring node 400. Finally, all the nodes of the ring network receive the RPL block-automatic protection switching frame 73. Further, the nodes 300 and 400 delete the blocking set for the ports 32 and 41 connected with the failure link when the failure occurs.

After the logical blocking is reconfigured, since the address lists included in the forwarding tables 130 to 630 of the nodes 100 to 600 are no longer valid of the changed topology, the nodes 100 to 600 delete the remaining address lists except for address lists corresponding to the ports 13, 23, 33, 43, 53, and 63 in the forwarding tables 130 to 630. Forwarding tables 140, 240, 340, 440, 540, and 640 from which some address lists are deleted are shown in FIG. 6.

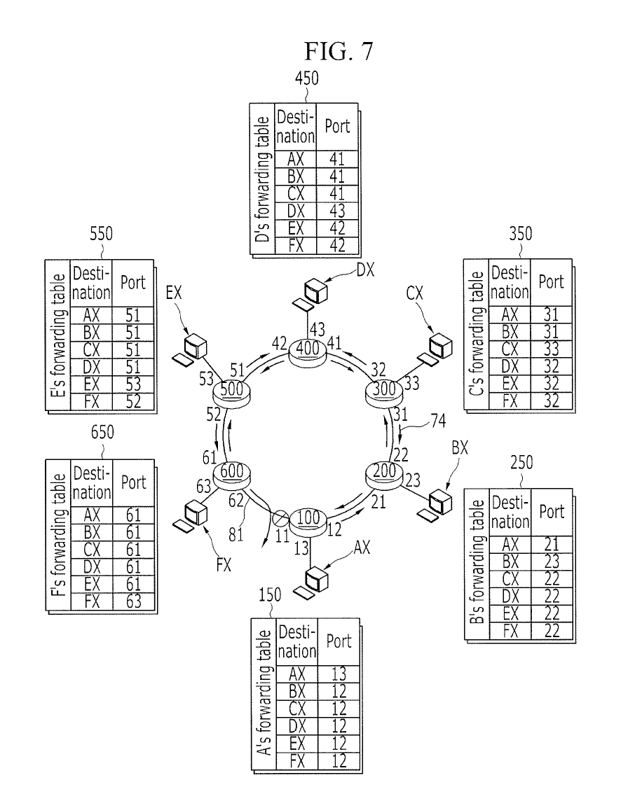

After, some of the lists of the forwarding tables 130 to 630 are deleted, and each of the nodes 100 to 600 generates the new forwarding table by reflecting the topology of the ring network changed by exchanging the automatic protection switching-subnet address list frame including the address list connected with the external network. This will be described in detail with reference to FIG. 7.

FIG. 7 is a diagram showing generation of a new forwarding table in a network according to an embodiment of the present invention.

Referring to FIG. 7, each of the nodes 100 to 600 generates the automatic protection switching-subnet address list frame 74, and includes information on the address lists connected with the port connected with the external network of the node in the frame. In case of the ring protection link owner, node 100, the process is performed just after it transmits the RPL block-automatic protection switching frame. In case of other nodes 200 to 600, the process is performed just after they receive the RPL block-automatic protection switching frame. The automatic protection switching-subnet address list frame is bi-directionally transmitted at the nodes except the ring protection link owner. The ring protection link owner 100 transmits the automatic protection switching-subnet address list frame only in a direction that the logical blocking does not exist.

A node receiving an automatic protection switching-subnet address list frame 74 copies the automatic protection switching-subnet address list frame 74, and thereafter transmits the copied frame 74 to the opposite direction and starts to update its forwarding table on the basis of the received frame 74. That is, in case of the deleted address lists in FIG. 6, the forwarding tables 150 to 650 are immediately updated through the source address learning function for the addresses included in the automatic protection switching-subnet address list frame.

The forwarding tables 150 to 650 disclose which port the frame is transmitted considering the logical blocking position. That is, referring to the forwarding table 150, when the destination address of a data frame originated from client AX is client FX, the port to be transmitted is determined as the port 12, not the port 11.

In the case where the failure occurs after the logical blocking is set such that the forwarding table needs to be updated or in the case where the failure is restored and the logical blocking is again set such that the forwarding table needs to be updated, all the address lists included in the forwarding table are not deleted, the ring nodes exchange their subnet address list information generated by using the address list information connected to the ports 13 to 63 without deleting the address lists corresponding to the ports 13, 23, 33, 43, 53, and 63, and the forwarding table is updated by using the indirect source address learning function for the received address list. Therefore, the forwarding table updated depending on the existing data frame is more rapidly updated through the automatic protection switching-subnet address list frames, such that it is possible to maintain the network more stably and efficiently use resources by preventing traffic that the nodes 100 to 600 transmit and receive from being diffused in all directions of the ring.

Meanwhile, although the embodiment has been described on the basis of the network having one ring shape, the present invention is not limited thereto, and the embodiment may be adopted even in a method for protection switching including a plurality of ring networks.

That is, in the case where the failure occurs in a lower ring network in the network including a lower ring network and an upper ring network that each include a plurality of nodes, the lower ring network and the upper ring network are connected to each other and the ring connection node included in the upper ring network may delete the forwarding table list. Then, the list connected to the lower ring network except for the external network may be deleted.

According to an embodiment of the present invention, it is possible to minimize the transient phenomenon in which the amount of traffic is overshot by deleting and initializing information of a forwarding table right after protection switching in a ring network. As a result, it is possible to prevent resources from being unnecessarily used and to perform rapid protection switching.

The above-mentioned exemplary embodiments of the present invention are not embodied only by an apparatus and method. Alternatively, the above-mentioned exemplary embodiments may be embodied by a program performing functions that correspond to the configuration of the exemplary embodiments of the present invention, or a recording medium on which the program is recorded.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for protection switching of a ring network, which includes a plurality of nodes disposed in a ring shape, comprising:
allowing the plurality of nodes to delete address lists connected with the ring network from their forwarding tables when topology of the ring network is changed;
allowing each of the plurality of nodes to transmit a subnet address list with ports associated with subnets in its forwarding table; and
allowing each of the plurality of nodes to update the forwarding table on the basis of the subnet address list.

2. The method of claim 1, wherein
the updating a forwarding table is performed on the basis of a source address learning process.

3. The method of claim 1, wherein
the case when the topology of the ring network is changed includes a case when a failure link occurs in the ring network, and
the protection switching method further includes
allowing a node adjacent to the failure link among the plurality of nodes to generate a failure protection switching frame when a failure link occurs in the ring network, and
allowing the node adjacent to the failure link to transmit the failure protection switching frame.

4. The method of claim 3, wherein
the deleting an address list includes
allowing the node adjacent to the failure link to delete the address list after transmitting the failure protection switching frame.

5. The method of claim 3, further comprising
allowing each of the plurality of nodes to receive the failure protection switching frame, and
the deleting an address list includes
allowing each node to delete an address list connected to the ring network in its forwarding table after receiving the failure protection switching frame.

6. The method of claim 3, wherein
the transmitting a subnet address list includes
transmitting the subnet address list included in a subnet address list protection switching frame,
when the subnet address list is larger than the maximum transmission size of the subnet address list protection switching frame, the subnet address list protection switching frame is divided and transmitted, and
each of the plurality of nodes separately processes the divided subnet address list protection switching frame.

7. The method of claim 6, wherein,
in the transmitting the subnet address list,
the node adjacent to the failure link transmits the subnet address list protection switching frame in an opposite side to the failure link.

8. The method of claim 1, wherein
the case when the topology of the ring network is changed includes a case when the failure link is restored in the ring network, and
the protection switching method further includes
allowing the node adjacent to the failure link to generate a restoration protection switching frame notifying of the restoration, and
allowing each of the plurality of nodes to receive the restoration protection switching frame.

9. The method of claim 8, further comprising:
setting logical blocking after receiving the restoration protection switching frame;
allowing a node managing the logical blocking among the plurality of nodes to generate a blocking protection switching frame notifying that the logical blocking is set;
allowing each of the plurality of nodes to receive the blocking protection switching frame;
allowing each of the plurality of nodes to delete a list connected with the ring network from the forwarding table;
allowing each of the plurality of nodes to transmit the subnet address list with ports connected with subnets in its forwarding table; and
allowing each of the plurality of nodes to update the forwarding table on the basis of the subnet address list.

10. The method of claim 9, wherein
the transmitting the subnet address list
includes transmitting the subnet address list included in the subnet address list protection switching frame, and
when the subnet address list is larger than the maximum transmission size of the subnet address list protection switching frame, the subnet address list protection switching frame is divided and transmitted,
wherein each of the plurality of nodes separately processes the divided subnet address list protection switching frame.

11. The method of claim 10, wherein
the transmitting the subnet address list
includes allowing the node managing the logical blocking to transmit the source address list protection switching frame to an opposite side to the logical blocking.

12. The method of claim 10, wherein
the transmitting the subnet address list includes
allowing the node managing the logical blocking to receive the source address list protection switching frame from a port where the logical blocking is positioned, wherein the node managing the logical blocking does not perform processing of the source address list frame and not transmit the source address list protection switching frame to the opposite side.

13. A method for protection switching of a network including a plurality of nodes connected in a structure of a plurality of rings, comprising:
when a failure occurs in a lower ring network of the ring network, allowing a node that connects an upper ring network with the lower ring network and is included in the ring network among the plurality of nodes to delete all entries connected with the ring networks from its forwarding table.

14. A method for protection switching of a node included in a ring network, comprising:
deleting address lists connected with the ring network from a node's own forwarding table when topology of the ring network is changed;
transmitting a subnet address list;
receiving a subnet address list from an adjacent node; and
updating the forwarding table on the basis of the subnet address list received from the adjacent node.

15. The method of claim 14, wherein
the updating a forwarding table is performed on the basis of a source address learning process.

16. The method of claim 14, wherein
the case when the topology of the ring network is changed includes a case when a failure link occurs in the ring network, and
the protection switching method further includes
generating a failure protection switching frame when the node is a node adjacent to the failure link, and
transmitting the failure protection switching frame to the adjacent node.

17. The method of claim 16, wherein:
the deleting the address list includes deleting the address list after transmitting the failure protection switching frame;
the transmitting the subnet address list includes transmitting the subnet address list protection switching frame to an opposite side to the failure link by including the subnet address list in a subnet address list protection switching frame;
when the subnet address list is larger than the maximum transmission size of the subnet address list protection switching frame, the subnet address list protection switching frame is divided and transmitted; and
the node separately processes the divided subnet address list protection switching frame.

18. The method of claim 14, wherein
the case when the topology of the ring network is changed includes a case when the failure link is restored in the ring network, and
the protection switching method further includes:
generating a restoration protection switching frame notifying the restoration when the node is a node adjacent to the failure link;
transmitting the restoration protection switching frame;
receiving a blocking protection switching frame notifying that logical blocking is set from a node managing the logical blocking after the logical blocking is set;
deleting a list connected with the ring network from the forwarding table;
transmitting the subnet address list to the adjacent node;
receiving the subnet address list from an adjacent node; and
updating the forwarding table on the basis of the subnet address list received from the adjacent node.

19. The method of claim 18, wherein
the transmitting the subnet address list includes
transmitting the subnet address list included in the subnet address list protection switching frame, and
when the subnet address list is larger than the maximum transmission size of the subnet address list protection switching frame, the subnet address list protection switching frame is divided and transmitted,
wherein each of the plurality of nodes separately processes the divided subnet address list protection switching frame.

20. The method of claim 18, wherein
the case when the topology of the ring network is changed includes a case when the failure link is restored in the ring network and the logical blocking is set, and
the protection switching method includes:
transmitting the source address list protection switching frame to an opposite side to the logical blocking when the node is the node managing the logical blocking: and
receiving the source address list protection switching frame from a port where the logical blocking is positioned,
wherein the node does not process the source address list protection switching frame without transmitting the source address list protection switching frame to the opposite side.
